(19) United States
(12) Patent Application Publication
(10) Pub. No.: US 2025/0252714 A1
(43) Pub. Date: Aug. 7, 2025

(54) RESOLUTION-SWITCHABLE SEGMENTATION NETWORKS

(71) Applicant: Intel Corporation, Santa Clara, CA (US)

(72) Inventors: Anbang Yao, Beijing (CN); Dongqi Cai, Beijing (CN); Ming Lu, Beijing (CN); Shandong Wang, Beijing (CN); Liang Cheng, Shanghai (CN); Yi Qian, Shanghai (CN); Yu Zhang, Beijing (CN); Yurong Chen, Beijing (CN)

(73) Assignee: Intel Corporation, Santa Clara, CA (US)

(21) Appl. No.: 18/855,943

(22) PCT Filed: May 16, 2022
(86) PCT No.: PCT/CN2022/093145

§ 371 Date: Oct. 10, 2024

(51) Int. Cl. G06V 10/774; G06V 10/32; G06V 10/82

(52) U.S. Cl. CPC G06V 10/774; G06V 10/32; G06V 10/82

(57) ABSTRACT

A computer model for object segmentation in images may be used for multiple input image sizes with shared convolutional layer parameters to be applied across application of the multiple image sizes. The model can also include size-specific parameters for one or more size-dependent layers, such as a normalization layer. The model may be trained with mixed-resolution training images in parallel in which the training image is resized to multiple sizes and the resulting predictions may learn the respective parameters in parallel based on an ensemble prediction as well as distillation from higher to lower resolution input image predictions.

### TECHNICAL FIELD

This disclosure relates generally to computer models for segmentation, and more particularly to effective image segmentation for different image sizes (resolutions).

### BACKGROUND

Segmentation of images may be used to identify a portion of an image that belongs to a given classification as distinguished from portions of the image that do not belong to that classification. For example, the classification of “human” may be used in Video Human Segmentation (VHS) as an increasingly critical requirement for many emerging AI applications such as video conferencing, live-streaming, broadcasting assistant, as well as online education. The basic goal of VHS is to precisely classify and extract human body pixels from image frames of a video with a trained segmentation model. However, top-performing deep neural networks (DNNs) usually lead to intensive storage, computation, and energy requirements. To make DNN solutions be applicable on resource-constrained computational platforms, substantial research efforts have been invested in successfully applying segmentation models to different input image resolutions (also termed image sizes). However, applying current DNN models for VHS, when the test frame resolution obviously differs from the frame resolution used for training, the segmentation accuracy quickly deteriorates. In some experiments, model accuracy may drop by 15% or more. As a result, modern segmentation networks typically train an individual model for each target frame resolution, with the total number of models trained (and resulting storage requirements for trained parameters) being highly affected by the number of target frame resolutions to be used in later inference. In addition to the storage and training costs, each time the target frame resolution is modified at inference, the size-specific model parameters (for the complete model) may need to be retrieved, causing significant delay.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A-1B show an example segmentation model for processing different input image sizes to generate respective segmentation outputs, according to one embodiment.

FIGS. 2A-2B show a data flow for training parameters of a segmentation model, according to one embodiment.

FIGS. 3A-3C show example segmentation with the segmentation model according to one embodiment.

FIG. 4 shows example computer model inference and computer model training.

FIG. 5 illustrates an example neural network architecture.

FIG. 6 is a block diagram of an example computing device that may include one or more components used for training, analyzing, or implementing a computer model in accordance with any of the embodiments disclosed herein.

### DETAILED DESCRIPTION

### Overview

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

A computer model for object segmentation in images may be used for multiple input image sizes (e.g., resolutions) with shared convolutional layer parameters to be applied across multiple image sizes. In some embodiments, the model also includes size-specific parameters for one or more size-specific layers, such as a normalization layer. Specifically, a mixed-resolution parallel training technique provides for learning the parameters of the model with multiple image resolutions of the same image.

The segmentation model may be trained with several approaches in various embodiments. First, the model with a shared convolutional layer may include image frames with different resolutions trained within a single model. As another example, as different frame resolutions may lead to different activation statistics in a network, to address mixed-resolution interaction effects, a size-dependent layer may privatize parameters for the size-dependent layer (e.g., use size-specific parameters). In one embodiment, the size-dependent layer(s) include normalization layers for normalizing output features and may include other types of layers (e.g., fully-connected layers) in various embodiments. When combined with the shared convolutional layer, the size-dependent layer may represent a small portion of the total learned network parameters, and in some examples less than 1% of the parameters of the whole model. This enables the model as a whole to account for different sizes effectively without significantly increasing the size of the model relative to a single-size model. In addition, to remove mixed-resolution interaction effects and significantly boost model performance on different input image resolutions, an ensemble segmentation prediction may also be generated and used to improve individual model size predictions based on a training loss relative to the ensemble segmentation. Finally, a distillation loss may also be generated based on the different image sizes and optionally including the ensemble segmentation prediction, as these predictions are generated relative to the same training image. As such, the distillation loss provides for the smaller-sized images to learn from the larger-sized images, encouraging the distillation of parameters and “knowledge” from one image size prediction to another as determined “on the fly” from the different predictions of the same image. After training, the resulting model can be switched with different input image resolutions and provide improved performance relative to individually-trained models (e.g., trained on a specific input size).

The segmentation is generally discussed with reference to human segmentation in an image (e.g., a frame of a video) as a dense/pixel-level classification problem (e.g., pixels in the image are characterized as “human” or “not human” as the segmentation task), although the same principles may be applied to any type (e.g., class) of segmentation, including multi-class segmentation.

As such, this training technique (which is applicable to other DNNs and classification tasks) may be used, e.g., for runtime-efficient video human segmentation applications and other image or video segmentation tasks. The ability of the resulting single model to switch the input frame resolution at inference meets a common need for real-life model deployments. By switching input frame resolutions, the running speeds and costs are adjustable to flexibly handle the real-time latency and power requirements for different application scenarios or workloads. In addition, the flexible latency compatibility allows the model to be adaptively deployed on a wide range of resource-constrained platforms.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. The meaning of “a,” “an,” and “the” include plural references. The meaning of “in” includes “in” and “on.”

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale. The terms “substantially,” “close,” “approximately,” “near,” and “about,” generally refer to being within +/−20% of a target value. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

### Segmentation Model for Multiple Input Image Sizes

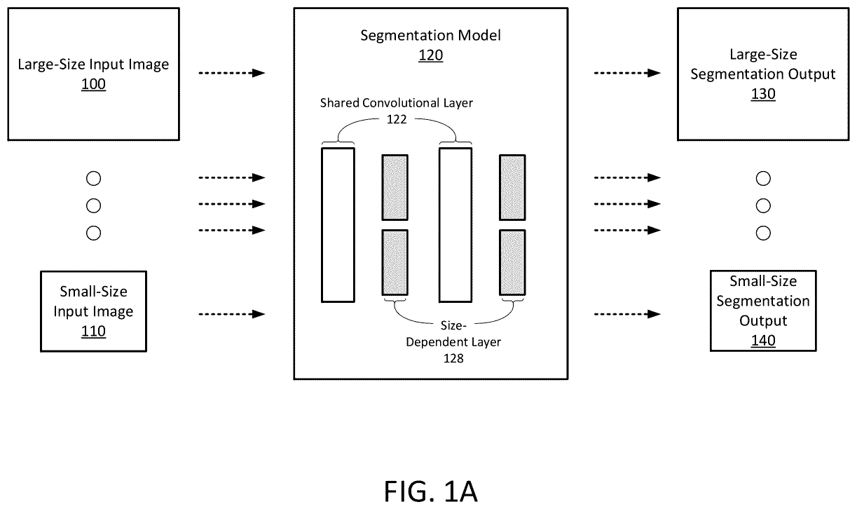

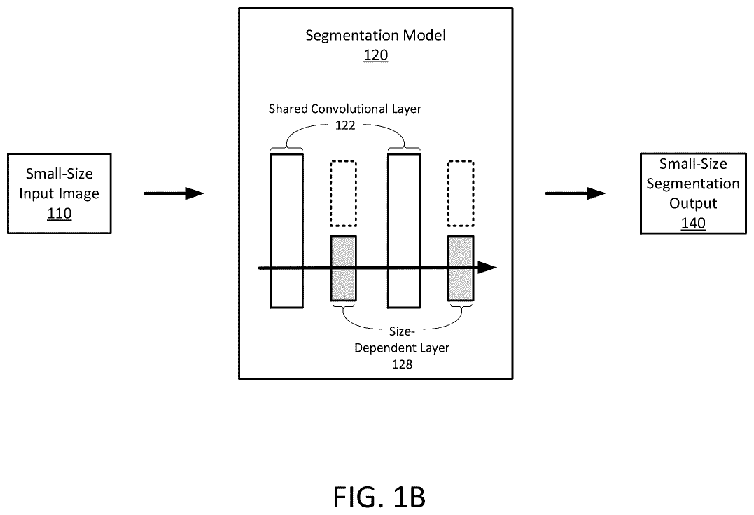

FIGS. 1A-B show an example segmentation model 120 for processing different input image sizes to generate respective segmentation outputs. FIG. 1A shows an example of the segmentation model 120 receiving various input sizes, shown in FIG. 1A as a large-size input image 100 and a small-size input image 110, which are processed by the segmentation model 120 to generate a large-size segmentation output 130 and a small-size segmentation output 140. While these sizes are shown in FIG. 1A, in practice the segmentation model 120 may be capable of effectively processing multiple different input sizes. Each input size (or resolution) represents a different input size that may be received by the segmentation model 120. For example, the input resolutions may be rectangular or square, and may vary in size according to the particular implementation. For example, one implementation includes image sizes/resolutions of 512×320, 448×288, 352×224, 256×160, and 160×96 image sizes. In this example, the largest image size was 512 by 320 pixels, and the smallest image size was 160 by 96 pixels. In different implementations, the image size may be a function of the size of the resolution of the camera capturing the image. In other examples, computation time for executing a segmentation model may significantly increase as the input size increases (e.g., as computation time is a function of the number of pixels in the input activation for the layer). As such, the image size may be reduced to reduce the required computation for processing an input image, such that the input size for processing a particular input image with the segmentation model 120 may be selected to affect the processing load of generating a segmentation output for a particular input image.

Application of the segmentation model 120 generates a corresponding segmentation output for the input image. As such, the segmentation model 120 applied to the large-size input image 100 generates a large-size segmentation output 130, and the segmentation model 120 applied to the small-size input image 110 generates the small-size segmentation output 140. The respective segmentation outputs 140 designate a segmentation of the input images 100, 110 according to the trained classification of the segmentation model 120.

Segmentation of an image generally refers to designation of individual portions (e.g., pixels, bounding boxes, or regions) of the image as belonging to a particular classification. In general, the discussion herein refers to segmentation of a human in an image (which may be an individual video frame), such that the segmentation output indicates a prediction from the model that individual portions of the input image belong to the classifications “human” or “not-human.” Such segmentation may be useful, for example, to outline or separate a human in a video from a background, or other objects and segmentation may be used in various additional image processing or automated perception tasks. For example, video conferencing software may use human segmentation to apply a virtual background to a classified “non-human” portion of an image frame while passing the “human” portion of the image frame through for presentation. Alternatively, the “human” portion in an image frame may be used to narrow a region for identifying a human face, apply a mask, other image processing, or filtering to the segmented “human” portion of the image.

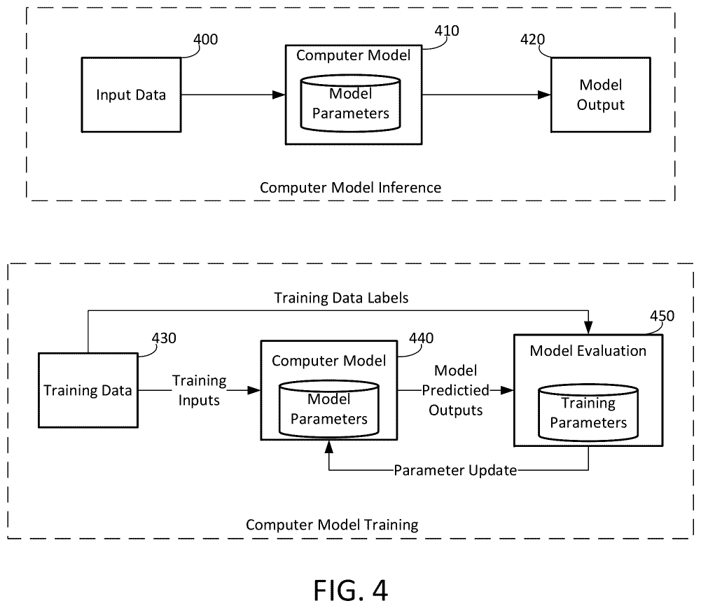

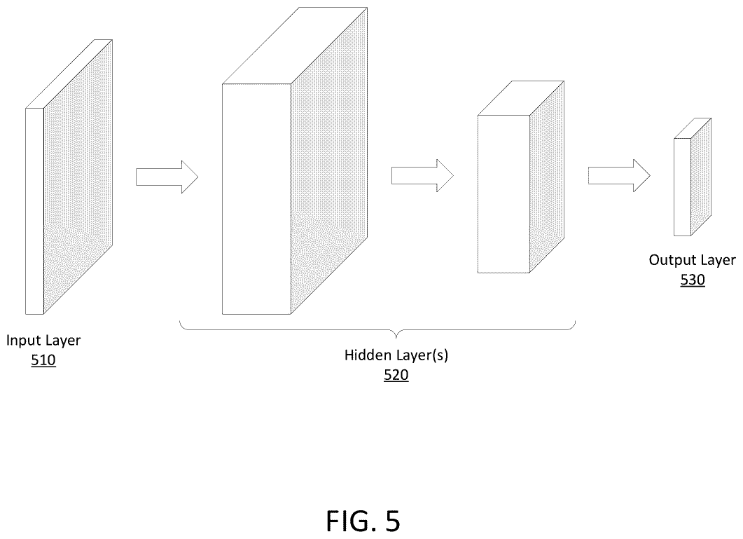

As discussed below with respect to FIGS. 4-5, computer models typically include parameters that are used to process inputs to predict outputs. Such computer models may be iteratively trained to learn parameters, including weights, for predicting various outputs based on input data. As discussed further in FIG. 5, individual layers in a neural network may receive input activations and process the input activations to generate output activations of the layer. The segmentation model 120 includes one or more shared convolutional layers 122 and may also include one or more size-dependent layers 128.

The shared convolutional layers 122 may have parameters that are the same when applied to input images of different sizes, while the size-dependent layers 128 may have parameters that differ when applied to different image sizes, such that the size-dependent layers 128 may apply size-specific parameters based on the image size. As such, the segmentation model 120 may be applied to images of different sizes, where the difference in the application of the segmentation model 120 is based on the difference in the size-dependent layers 128. In some embodiments, the parameters of the shared convolutional layers 122 include the majority (or vast majority) of the total parameters of the model, and in some circumstances, the size-dependent layers 128 include 5%, 3%, 1%, or less of the parameters of the segmentation model 120. This may permit the segmentation model 120 to effectively be applied to different image sizes (and smoothly switched between different image sizes) without requiring individual computer models.

FIG. 1B shows an example application of the segmentation model 120 to the small-size input image 110. In this example, the segmentation model 120 applies the parameters of the shared convolutional layers 122 to the small-size input image 110. In addition, the parameters of the size-dependent layers 128 are selected and applied based on the size of the small-size input image 110, such that the corresponding parameters for the input resolution (i.e., the size) are used. After applying the shared convolutional layers 122 and size-specific parameters of the size-dependent layer 128, the small-size segmentation output 140 is generated for the small-size input image 110. Similarly, applying the segmentation model 120 to another model size would use the parameters of the shared convolutional layer 122 and the respective size-specific parameters of the size-dependent layers 128.

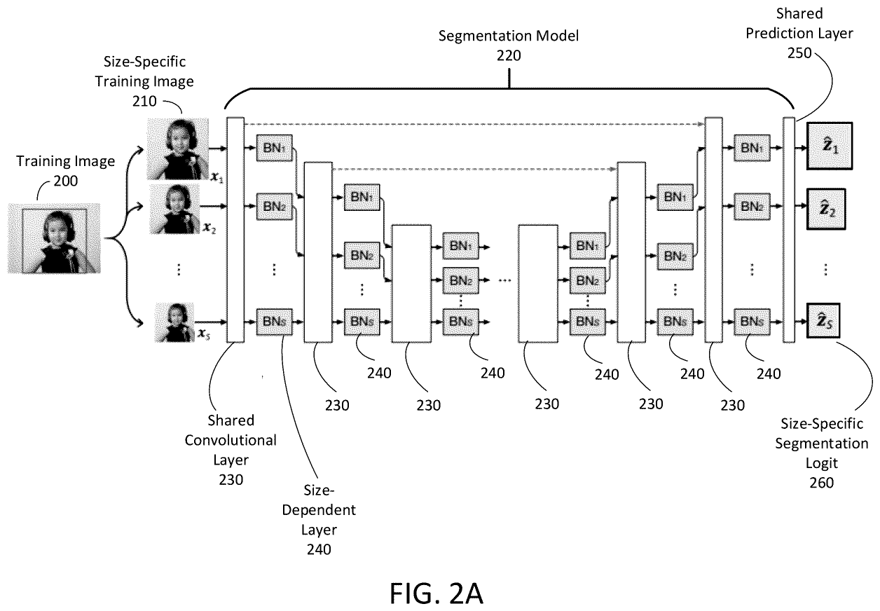

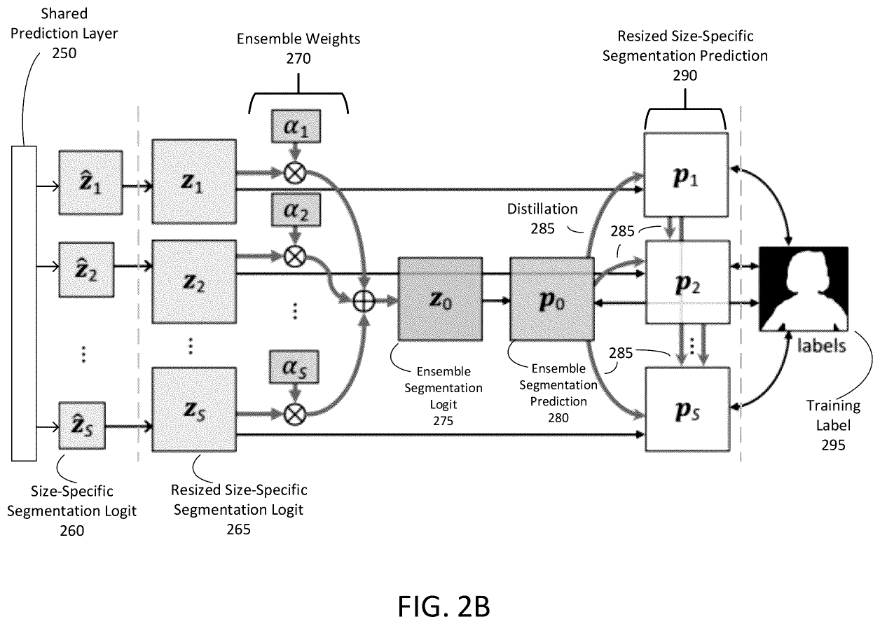

FIGS. 2A-2B show a data flow for training parameters of a segmentation model, according to one embodiment. In the example of FIGS. 2A-2B, the segmentation model includes several shared convolutional layers 230 and size-dependent layers 240. In this example, the segmentation model 220 is a “U-net” model, such that the convolutional layers may generate particular features and reduces the size of the input image through layers of the model and subsequently increases the size of the data while also feeding data forward from prior layers. While a U-net structure is shown in FIG. 2A, the joint training and size-switchable segmentation models discussed herein may be applied to segmentation models of various sizes, types, and shapes that include convolutional layers with parameters that may be shared by multiple input image sizes. While generally referring to convolutional layers, additional types of layers may also have parameters shared across image sizes.

In this example, the shared convolutional layers 230 are alternated with size-dependent layers 240. The segmentation model 220 may also include size-dependent layers 240, such as normalization (or other) layers that learn size-specific parameters to be applied to particular input image sizes. In this embodiment, the size-dependent layers 240 are batch normalization layers. Finally, the segmentation model 220 may output size-specific segmentation logits 260 (also referred to as 2) based on a shared prediction layer 250. In one embodiment, the shared prediction layer 250 is a type of shared layer that generates a prediction with respect to one or more classes and may generate regression logits for the respective classes as further discussed in FIG. 2B. The regression logits for the classes describe a likelihood for that class without respect to other possible classes and may be further processed to convert the class-specific logits (e.g., the respective raw values for each classification) to class probabilities p, for example, by applying a SoftMax function to the class logits.

As such, although the segmentation model 220 in this example includes many size-dependent layers 240, because the size-dependent layers 240 are normalization layers, the number of size-specific parameters, even for the plurality of different image sizes, is typically much smaller than the number of parameters to be learned for the respective shared convolutional layers 230, which include k×k×c weights for each k×k filter size for an activation input having c channels for each filter in the shared convolutional layer 230.

In this example, the size-specific models and their respective inputs and outputs are designated with subscripts 1 through s. For example, the respective parameters of the size-dependent layers 240 are designated BN₁, BN₂, . . . BNₛ. Similarly, the input images at different sizes are designated x₁, x₂, xₛ, and the size-specific segmentation prediction \hat{z} is designated for specific sizes as \hat{z}₁, \hat{z}₂, . . . , \hat{z}ₛ.

To learn the parameters of the segmentation model 220, a set of training images 200 have labeled segmentation classifications are used for training the segmentation model 220 with various sizes of each particular training image 200. In one embodiment, a training image 200 is cropped to a selected portion of the image and resized to a set of size-specific training images 210 (size-specific training images x₁ⁱ, x₂ⁱ, . . . , xₛⁱ). In one embodiment, the cropped area of the training image 200 is the size of the largest image size that may be used in the segmentation model 220. For example, in the embodiment having five sizes discussed above in which the largest image size is 512×320, the training image 200 may be cropped to a size of 512×320 to generate a size-specific training image x₁ and then resized to the other size-specific training images 210. In addition, the selection of the cropped region may be randomly selected within the training image 200 and may differ for different training images. For a given training image 200 and its associated label, however, the same training image may thus be used to create a respective set of size-specific training images 210. Each of the size-specific training images 210 may be processed by the segmentation model 220 through the shared convolutional layers 230 and respective size-dependent layers 240 (e.g., BN₁ for x₁, BN₂ for x₂, etc.) to generate the set of respective size-specific segmentation logits 260 (e.g., \hat{z}₁ for x₁, \hat{z}₂ for x₂, etc.).

As the size-specific training images 210 provide the same training image 200 at different sizes, the same label for the training image may be used to train the model parameters that account for how the same image input at different sizes is differently predicted by the segmentation model. In one embodiment, the model may thus be trained based on a training loss that optimizes for the joint loss across the different training sizes for the size-specific training images 210 of the same training image 200. By training the different sizes in parallel with the same training image 200, the effect of modifying parameters for different image sizes, particularly for the shared layer parameters, can be simultaneously optimized.

In one embodiment, the parameters may be trained in parallel to minimize a cross-entropy loss of the classification error. Given model parameters θ, the probability of the class c for an image xⁱ may be described as p(c|xⁱ,θ); in which a cross-entropy loss may be determined by:

$$H ( x , y ) = - \frac{1}{N} {\sum }_{i = 1}^{N} {\sum }_{c = 1}^{C} δ ( c , {y}^{i} ) log ( p ( c \vert {x}^{i} , θ ) ) \qquad Equation 1$$

In which:
H(x,y) is the cross-entropy loss for image xⁱ with respective pixel-wise training labels yⁱ for a set of X training images X={x₁ⁱ, x₂ⁱ, . . . , xₛⁱ,yⁱ)|i∈{1, 2, . . . , N}}; and Where: δ(c,yⁱ)=1 when c=yⁱ, otherwise 0.

As one example of a training loss describing the classification loss [symbol] for the predicted classes (based on the set of size-specific segmentation logits 260), Equation 1 may be modified to account for the multiple predictions and generated size-specific training images for each training image in X. As such, the training set expands to include the size-specific training images 210 and respective labels: {(x₁ⁱ, x₂ⁱ, . . . , xₛⁱ,yⁱ)|i∈{1, 2, . . . , N}}. As such, given the expanded set of images with various image sizes, in one embodiment the cross-entropy loss may sum the cross-entropy loss across the size-specific training images 210:

$${ℒ}_{cls} = {\sum }_{s = 1}^{S} H ( {x}_{s} , y ) \qquad Equation 2$$

By applying a training loss according to Equation 2, the segmentation model 220 may learn parameters that optimize the training loss for multiple training images at multiple sizes simultaneously. In addition, different resolutions of the training image may generate activations at different portions of the network as they differ in spatial size. In embodiments that include size-dependent layers 240, the different activations may be accounted for, for example, via the mean and normalization parameters of batch normalization.

FIG. 2B continues the example of FIG. 2A to show additional further components of a training loss function in further embodiments. While the example of FIG. 2A may be trained as discussed above, additional modifications may also be applied as shown in FIG. 2B. In particular, in one embodiment as the size-specific segmentation logits 260 are the same size as the respective input images, the segmentation logits 260 may be resized to the resolution of the largest input image resolution to form a set of resized size-specific segmentation logits 265, designated z₁, z₂, . . . zₛ. In embodiments in which the segmentation logits 260 are resized to the size of the largest input image resolution, the largest size-specific segmentation logit 260 may not be resized as it is already the size of the resized size-specific segmentation logits (e.g., \hat{z}₁=z₁). As such, the resized size-specific segmentation logits 265 may be used to generate class/segmentation predictions that may adjust for the relative size of the different output images and may be comparable with the same size training label 295. In addition, by resizing the size-specific segmentation logits, they may also be combined to form an ensemble logit as further discussed below.

As the resized size-specific segmentation logits 265 may represent unnormalized outputs for the respective classes (e.g., classes “human” and “not human” for human segmentation), the corresponding resized size-specific segmentation predictions 290 may be generated (e.g., p₁ for z₁, p₂ for z₂, etc.) by applying a Softmax function:

$$p ( c \vert {x}^{i} , θ ) = p ( c \vert {z}^{i} ) = \frac{exp ( {z}_{c}^{i} )}{{\sum }_{j = 1}^{C} exp ( {z}_{c}^{i} )} , c ∈ \{ 1 , 2 , … C \} \qquad Equation 3$$

A corresponding version of Equation 3 may be used to determine class predictions (without resizing) for the size-specific segmentation logits 260. In combination with Equations 1 and 2, Equation 3 may be used to calculate class probabilities used for the classification loss for the model weights.

In one embodiment, an ensemble segmentation prediction 280 may also be generated and used to further improve training of the model parameters. In particular, different sizes of input images, along with the respective model sizes and parameters, may provide different information about classification. Stated another way, different resolutions may be complimentary to one another in the represented information in the model. Because the resized size-specific segmentation logits 265 are the same size, these may be combined to form an ensemble segmentation logit 275 and a corresponding ensemble segmentation prediction 280 according to Equation 3. The ensemble segmentation logit 275 is referred to as z₀ and the ensemble segmentation prediction 280 is referred to as p₀. To generate the ensemble segmentation logit 275, the resized size-specific segmentation logits 265 may be combined, and in one embodiment are weighed according to a set of ensemble weights 270. Formally, the set of ensemble weights 270 may be referred to in one embodiment as α=[α₁ α₂ . . . αₛ], such that the ensemble segmentation logit 275 is the sum of the weights applied to the resized size-specific segmentation logits 265 as formally given by: z₀=Σₛ₌₁^{S} αₛ zₛ. As such, the ensemble logit (z₀) may be learned “on the fly” as a weighted mean of logits (of the model's prediction for multiple sizes of the same training image), which are resized to have the same resolution.

In one embodiment, a component of the training loss is based on the ensemble segmentation prediction 280 and may also be used to optimize the values for the ensemble weights 270. In this example, the ensemble loss [symbol] may be a cross-entropy loss between the ensemble segmentation prediction 280 and the training labels:

$${ℒ}_{ens} = - \frac{1}{N} {\sum }_{i = 1}^{N} {\sum }_{c = 1}^{C} δ ( c , {y}^{i} ) log ( p ( c \vert {z}_{θ}^{i} ) ) \qquad Equation 4$$

In one embodiment, when optimizing for parameters of the ensemble weights 270, the parameters of the size-specific segmentation logits 260 may be held constant.

Finally, an additional training loss component may be included based on a distillation 285 of the “knowledge” from the predictions based on larger-size images to the predictions of lower-size images (e.g., from p₁ to p₂, from p₂ to p₃, etc.). This permits the learning from one prediction to be distributed to the prediction of other image sizes and provides another pathway for the “correct” prediction to be learned by parameters affecting the lower-size models. This may be effective here as each of the predictions may relate to different sizes of the same training image, such that the “teaching” prediction is with respect to the same training data and label. In the distillation loss, a “teacher” prediction pₜ is used to guide a “student” prediction pₛ, such that the student is encouraged to align its prediction with the teacher prediction. In one embodiment, the student is encouraged to learn the teacher based on a distillation loss [symbol] defined by the ensemble segmentation prediction p₀:

$${ℒ}_{dis} = {\sum }_{s = 1}^{S} {𝒟}_{kl} ( {p}_{0} \vert \vert {p}_{s} ) \qquad Equation 5$$

As shown in Equation 5, the prediction of the resized size-specific segmentation predictions (p₁ through pₛ) may be encouraged to follow the ensemble prediction p₀. The Kullback-Leibler (kl) divergence term [symbol] for the distillation loss, for a general teacher pₜ and student pₛ may be given by:

$${𝒟}_{kl} ( {p}_{t} \vert \vert {p}_{s} ) = \frac{1}{N} {\sum }_{i = 1}^{N} {\sum }_{c = 1}^{C} p ( c \vert {z}_{t}^{i} ) log \frac{p ( c \vert {z}_{t}^{i} )}{p ( c \vert {z}_{s}^{i} )} \qquad Equation 6$$

In addition to the distillation loss for the ensemble term, a distillation 285 may also be used based on the image input size, such that the higher-resolution input sizes “teach” the lower-resolution input sizes, such that predictions of larger image sizes guide the predictions for smaller image sizes. In this way, the order in which the models “teach” one another may be based on an order of the respective image resolutions used in the predictions. In one embodiment, each prediction receives a distillation loss from all predictions of “higher” image resolutions, and further, the highest-resolution image may also receive a distillation loss from the ensemble segmentation prediction 280. An example of this distillation loss is:

$${ℒ}_{dis} = \frac{2}{S + 1} {\sum }_{t = 0}^{S - 1} {\sum }_{s = t + 1}^{S} {𝒟}_{kl} ( {p}_{t} \vert \vert {p}_{s} ) \qquad Equation 7$$

In Equation 7, the index t begins with the ensemble term and applies the loss downward from higher resolutions to lower resolutions. As such, this distillation loss can be applied “on the fly” without pre-training a teacher prediction and may also provide a way to benefit from the ensemble segmentation prediction 280 (itself a combination of the predictions at different sizes of the same image). As a result, the components of the training loss may include a classification loss, ensemble loss, and distillation loss based on different sizes of the same training image and encourage effective training of the parameters at several different sizes jointly with parameter sharing across the sizes. Formally, the training loss may thus be described by: [symbol] = [symbol] + [symbol] + [symbol] . After training, the learned model may be applied to several image sizes effectively (e.g., as discussed with respect to FIGS. 1A-B) and without significant parameter overhead, allowing for smooth adjustment to image size and associated computational effort. In use, the model may be applied to different image sizes with the learned parameters for the shared convolutional layer(s) and respective parameters for the size-dependent layer(s) 128; the ensemble and distillation components may be used for training and discarded.

### Experimental Results

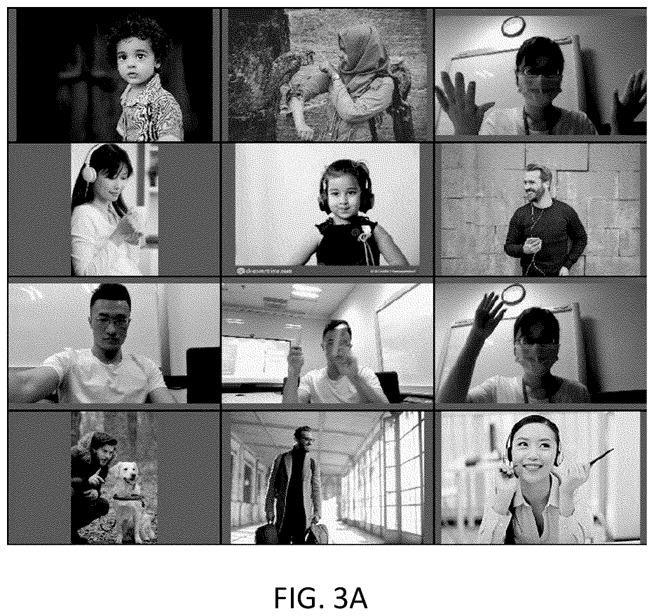

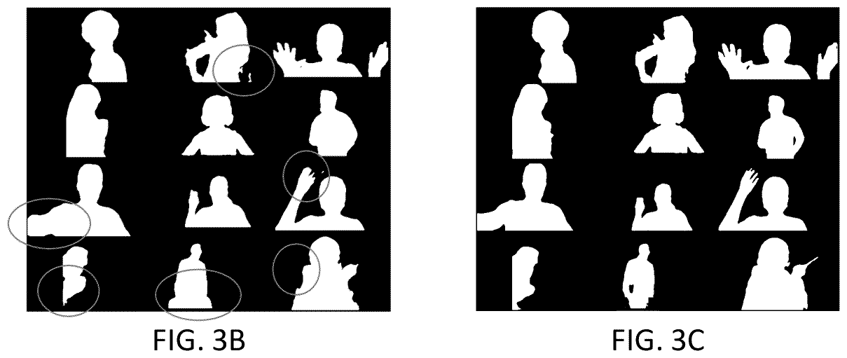

FIGS. 3A-C illustrate example segmentation according to one embodiment of the invention based on the training discussed in FIGS. 2A-2B. FIG. 3A shows an illustration of the labeled training data, while FIG. 3B shows the segmentation predictions for an individually-trained model at a resolution of 160×96 for input images, while FIG. 3C shows the improved segmentation predictions, using the same model structure as FIG. 3B, when modified with shared convolutional layers and trained with multiple sizes as discussed in FIGS. 2A-2B. That is, while the model input resolutions are the same, the shared convolutional layers and joint training yields significant improvement to segmentation. The results in FIG. 3C show the model's improvement in capturing additional detail and removing incorrect pixels.

Additional experiments were conducted on a large-scale commercial video human segmentation benchmark, consisting of tens of millions of video frames covering many application scenarios including video conference, live-streaming, broadcasting assistant, and online education. U−Net+MobileNetV2 and RefineNet+ResNet101 were used as two test cases. According to the real application requirements, five input image resolutions were trained, S′={512×320, 448×288, 352×224, 256×160, 160×96}. Table 1 and Table 2 summarize the detailed result comparisons, showing significant accuracy gains to the baseline models trained individually for each input frame resolution by the models trained as discussed in FIGS. 2A-2B.

| | mIoU for | | | | |
|---|---|---|---|---|---|
| Method | 512 × 320 | 448 × 288 | 352 × 224 | 256 × 160 | 160 × 96 |
| Individual training | 90.5 | 89.1 | 86.5 | 83.0 | 78.0 |
| (baseline) | | | | | |
| Our parallel training+ | 94.5 (4.0↑) | 94.2(5.1↑) | 93.8(7.3↑) | 91.5(8.5↑) | 89.4(11.4↑) |

Table 1: mIoU (%) comparison of individual models (U−Net+MobileNetV2 as a test case) trained and tested with the same input frame resolution, and with a single model on a large-scale commercial video human segmentation benchmark. With the single architecture for multiple resolutions discussed above, the result achieves 5× less memory cost, 2.1˜9.2×speed-up at better accuracy (matching a small resolution to a larger resolution), 4.0˜11.4% absolute mIoU boost, compared to 5 individual models.

| | mIoU for | | | | |
|---|---|---|---|---|---|
| Method | 512 × 320 | 448 × 288 | 352 × 224 | 256 × 160 | 160 × 96 |
| Individual training | 91.5 | 90.7 | 88.4 | 84.6 | 80.2 |
| (baseline) | | | | | |
| Our parallel training+ | 95.6(4.1↑) | 95.0(4.3↑) | 94.2(5.8↑) | 93.5(8.9↑) | 90.8(10.6↑) |

Table 2: mIoU (%) comparison of individual models (RefineNet+ResNet101 as a test case) trained and tested with the same input frame resolution, and the disclosed model on a large-scale commercial video human segmentation benchmark collected by AXG. With the disclosed approach, the results achieve 5× less memory cost, 2.9˜11.6× speed-up at better accuracy (matching a small resolution to a larger resolution), and 4.1˜10.6% absolute mIoU boost, compared to 5 individual models.

### Example Computer Modeling

FIG. 4 shows example computer model inference and computer model training. Computer model inference refers to the application of a computer model 410 to a set of input data 400 to generate an output or model output 420. The computer model 410 determines the model output 420 based on parameters of the model, also referred to as model parameters. The parameters of the model may be determined based on a training process that finds an optimization of the model parameters, typically using training data and desired outputs of the model for the respective training data as discussed below. The output of the computer model may be referred to as an “inference” because it is a predictive value based on the input data 400 and based on previous example data used in the model training.

The input data 400 and the model output 420 vary according to the particular use case. For example, for computer vision and image analysis, the input data 400 may be an image having a particular resolution, such as 75×75 pixels, or a point cloud describing a volume. In other applications, the input data 400 may include a vector, such as a sparse vector, representing information about an object. For example, in recommendation systems, such a vector may represent user-object interactions, such that the sparse vector indicates individual items positively rated by a user. In addition, the input data 400 may be a processed version of another type of input object, for example representing various features of the input object or representing preprocessing of the input object before input of the object to the computer model 410. As one example, a 1024×1024 resolution image may be processed and subdivided into individual image portions of 64×64, which are the input data 400 processed by the computer model 410. As another example, the input object, such as a sparse vector discussed above, may be processed to determine an embedding or another compact representation of the input object that may be used to represent the object as the input data 400 in the computer model 410. Such additional processing for input objects may themselves be learned representations of data, such that another computer model processes the input objects to generate an output that is used as the input data 400 for the computer model 410. Although not further discussed here, such further computer models may be independently or jointly trained with the computer model 410.

As noted above, the model output 420 may depend on the particular application of the computer model 410, and represent recommendation systems, computer vision systems, classification systems, labeling systems, weather prediction, autonomous control, and any other type of modeling output/prediction.

The computer model 410 includes various model parameters, as noted above, that describe the characteristics and functions that generate the model output 420 from the input data 400. In particular, the model parameters may include a model structure, model weights, and a model execution environment. The model structure may include, for example, the particular type of computer model 410 and its structure and organization. For example, the model structure may designate a neural network, which may be comprised of multiple layers, and the model parameters may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 410 processes the input data 400 to the model output 420. Each portion or layer of the computer model 410 may have such weights. For example, weights may be used to determine values for processing inputs to determine outputs at a particular portion of a model. Stated another way, for example, model weights may describe how to combine or manipulate values of the input data 400 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model. For example, portions of the model may be implemented in various types of circuitry, such as general-purpose circuitry (e.g., a general CPU), circuitry specialized for certain computer model functions (e.g., a GPU or programmable Multiply-and-Accumulate circuit) or circuitry specially designed for the particular computer model application. In some configurations, different portions of the computer model 410 may be implemented on different types of circuitries. As discussed below, training of the model may include optimizing the types of hardware used for certain aspects of the computer model (e.g., co-trained), or may be determined after other parameters for the computer model are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters for the computer model 440. During training, the model parameters are optimized to “learn” values of the model parameters (such as individual weights, activation values, model execution environment, etc.), that improve the model parameters based on an optimization function that seeks to improve a cost function (also sometimes termed a loss function). Before training, the computer model 440 has model parameters that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 430 includes a data set to be used for training the computer model 440. The data set varies according to the particular application and purpose of the computer model 440. In supervised learning tasks, the training data typically includes a set of training data labels that describe the training data and the desired output of the model relative to the training data. For example, for an object classification task, the training data may include individual images in which individual portions, regions or pixels in the image are labeled with the classification of the object. For this task, the training data may include a training data image depicting a dog and a person and training data labels that label the regions of the image that include the dog and the person, such that the computer model is intended to learn to also label the same portions of that image as a dog and a person, respectively.

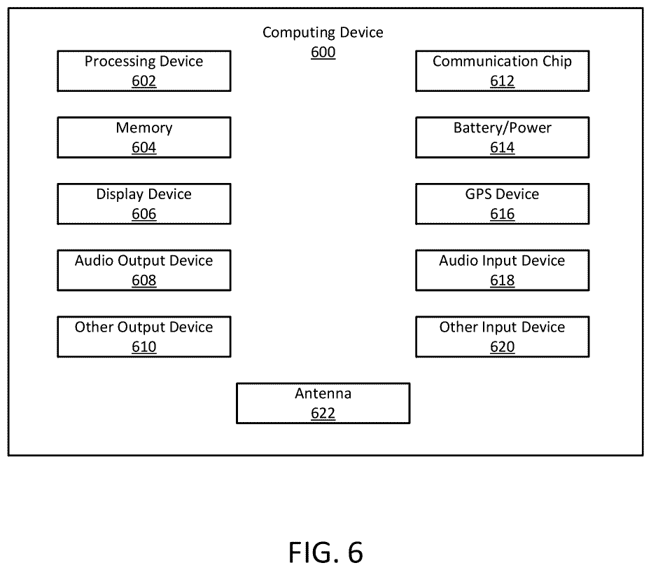

To train the computer model, a training module (not shown) applies the training data 430 to the computer model 440 to determine the outputs predicted by the model for the given training data 430. The training module, though not shown, is a computing module used for performing the training of the computer model by executing the computer model according to its inputs and outputs given the model's parameters and modifying the model parameters based on the results. The training module may apply the actual execution environment of the computer model 440, or may simulate the results of the execution environment, for example to estimate the performance, runtime, memory, or circuit area (e.g., if specialized hardware is used) of the computer model. The training module, along with the training data and model evaluation, may be instantiated in software and/or hardware by one or more processing devices such as the example computing device 600 shown in FIG. 6. In various examples, the training process may also be performed by multiple computing systems in conjunction with one another, such as distributed/cloud computing systems.

After processing the training inputs according to the current model parameters for the computer model 440, the model's predicted outputs are evaluated 450 and the computer model is evaluated with respect to the cost function and optimized using an optimization function of the training model. Depending on the optimization function, particular training processes and training parameters after the model evaluation are updated to improve the optimization function of the computer model. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model and may be measured in various ways, such as the precision (frequency of false positives) and recall (frequency of false negatives). The cost function in some circumstances may evaluate may also evaluate other characteristics of the model, for example the model complexity, processing speed, memory requirements, physical circuit characteristics (e.g., power requirements, circuit throughput) and other characteristics of the computer model structure and execution environment (e.g., to evaluate or modify these model parameters).

After determining results of the cost function, the optimization function determines a modification of the model parameters to improve the cost function for the training data. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data is batched and the parameter updates are iteratively applied to batches of the training data. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data available or the incremental improvements in model parameters are below a threshold (e.g., additional training data no longer continues to improve the model parameters). Additional training parameters may describe the batch size for the training data, a portion of training data to use as validation data, the step size of parameter updates, a learning rate of the model, and so forth. Additional techniques may also be used to determine global optimums or address nondifferentiable model parameter spaces.

FIG. 5 illustrates an example neural network architecture. In general, a neural network includes an input layer 510, one or more hidden layers 520, and an output layer 530. The values for data in each layer of the network is generally determined based on one or more prior layers of the network. Each layer of a network generates a set of values, termed “activations” that represent the output values of that layer of a network and may be the input to the next layer of the network. For the input layer 510, the activations are typically the values of the input data, although the input layer 510 may represent input data as modified through one or more transformations to generate representations of the input data. For example, in recommendation systems, interactions between users and objects may be represented as a sparse matrix. Individual users or objects may then be represented as an input layer 510 as a transformation of the data in the sparse matrix relevant to that user or object. The neural network may also receive the output of another computer model (or several) as its input layer 510, such that the input layer 510 of the neural network shown in FIG. 5 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network (except for the final output layer of 530 of the network).

Each layer of the neural network typically represents its output activations (i.e., also termed its outputs) in a matrix, which may be 1, 2, 3, or n-dimensional according to the particular structure of the network. As shown in FIG. 5, the dimensionality of each layer may differ according to the design of each layer. The dimensionality of the output layer 530 depend on the characteristics of the prediction made by the model. For example, a computer model for multi-object classification may generate an output layer 530 having a one-dimensional array in which each position in the array represents the likelihood of a different classification for the input layer 510. In another example for classification of portions of an image, the input layer 510 may be an image having a resolution, such as 512×512, and the output layer may be a 512×512×n matrix in which the output layer 530 provides n classification predictions for each of the input pixels, such that the corresponding position of each pixel in the input layer 510 in the output layer 530 is an n-dimensional array corresponding to the classification predictions for that pixel.

The hidden layers 520 provide output activations that variously characterize the input layer 510 in various ways that assist in effectively generating the output layer 530. The hidden layers thus may be considered to provide additional features or characteristics of the input layer 510. Though two hidden layers are shown in FIG. 5, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 530. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 510 is reached.

### Example Devices

FIG. 6 is a block diagram of an example computing device 600 that may include one or more components used for training, analyzing, or implementing a computer model in accordance with any of the embodiments disclosed herein. For example, the computing device 600 may include a training module for training a segmentation model or a segmentation module for receiving an image and applying the segmentation model to the image.

A number of components are illustrated in FIG. 6 as included in the computing device 600, but any one or more of these components may be omitted or duplicated, as suitable for the application. In some embodiments, some or all of the components included in the computing device 600 may be attached to one or more motherboards. In some embodiments, some or all of these components are fabricated onto a single system-on-a-chip (SoC) die.

Additionally, in various embodiments, the computing device 600 may not include one or more of the components illustrated in FIG. 6, but the computing device 600 may include interface circuitry for coupling to the one or more components. For example, the computing device 600 may not include a display device 606, but may include display device interface circuitry (e.g., a connector and driver circuitry) to which a display device 606 may be coupled. In another set of examples, the computing device 600 may not include an audio input device 618 or an audio output device 608 but may include audio input or output device interface circuitry (e.g., connectors and supporting circuitry) to which an audio input device 618 or audio output device 608 may be coupled.

The computing device 600 may include a processing device 602 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 602 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 600 may include a memory 604, which may itself include one or more memory devices such as volatile memory (e.g., dynamic random-access memory (DRAM)), nonvolatile memory (e.g., read-only memory (ROM), flash memory, solid state memory, and/or a hard drive). The memory 604 may include instructions executable by the processing device for performing methods and functions as discussed herein. Such instructions may be instantiated in various types of memory, which may include non-volatile memory and as stored on one or more non-transitory mediums. In some embodiments, the memory 604 may include memory that shares a die with the processing device 602. This memory may be used as cache memory and may include embedded dynamic random-access memory (eDRAM) or spin transfer torque magnetic random-access memory (STT-MRAM).

In some embodiments, the computing device 600 may include a communication chip 612 (e.g., one or more communication chips). For example, the communication chip 612 may be configured for managing wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 612 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 612 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 612 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 612 may operate in accordance with other wireless protocols in other embodiments. The computing device 600 may include an antenna 622 to facilitate wireless communications and/or to receive other wireless communications (such as AM or FM radio transmissions).

In some embodiments, the communication chip 612 may manage wired communications, such as electrical, optical, or any other suitable communication protocols (e.g., the Ethernet). As noted above, the communication chip 612 may include multiple communication chips. For instance, a first communication chip 612 may be dedicated to shorter-range wireless communications such as Wi-Fi or Bluetooth, and a second communication chip 612 may be dedicated to longer-range wireless communications such as global positioning system (GPS), EDGE, GPRS, CDMA, WiMAX, LTE, EV-DO, or others. In some embodiments, a first communication chip 612 may be dedicated to wireless communications, and a second communication chip 612 may be dedicated to wired communications.

The computing device 600 may include battery/power circuitry 614. The battery/power circuitry 614 may include one or more energy storage devices (e.g., batteries or capacitors) and/or circuitry for coupling components of the computing device 600 to an energy source separate from the computing device 600 (e.g., AC line power).

The computing device 600 may include a display device 606 (or corresponding interface circuitry, as discussed above). The display device 606 may include any visual indicators, such as a heads-up display, a computer monitor, a projector, a touchscreen display, a liquid crystal display (LCD), a light-emitting diode display, or a flat panel display, for example.

The computing device 600 may include an audio output device 608 (or corresponding interface circuitry, as discussed above). The audio output device 608 may include any device that generates an audible indicator, such as speakers, headsets, or earbuds, for example.

The computing device 600 may include an audio input device 618 (or corresponding interface circuitry, as discussed above). The audio input device 618 may include any device that generates a signal representative of a sound, such as microphones, microphone arrays, or digital instruments (e.g., instruments having a musical instrument digital interface (MIDI) output).

The computing device 600 may include a GPS Device 616 (or corresponding interface circuitry, as discussed above). The GPS Device 616 may be in communication with a satellite-based system and may receive a location of the computing device 600, as known in the art.

The computing device 600 may include an other output device 610 (or corresponding interface circuitry, as discussed above). Examples of the other output device 610 may include an audio codec, a video codec, a printer, a wired or wireless transmitter for providing information to other devices, or an additional storage device.

The computing device 600 may include an other input device 620 (or corresponding interface circuitry, as discussed above). Examples of the other input device 620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 600 may have any desired form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, the computing device 600 may be any other electronic device that processes data.

### Select Examples

The following paragraphs provide various examples of the embodiments disclosed herein.

Example 1 provides a method including: resizing a training image to a plurality of training images at different image resolutions; generating a plurality of size-specific segmentation outputs by applying each of the training images to a computer model to generate an associated size-specific segmentation prediction for each training image resolution, the computer model having a shared convolutional layer with the same parameters applied to each image resolution; and training parameters of the computer model, including parameters of the shared convolutional layer, based on a comparison of the plurality of size-specific segmentation predictions with a label of the training image.

Example 2 provides for the method of example 1, wherein the computer model includes one or more size-dependent layers with size-specific parameters.

Example 3 provides for the method of example 2, wherein the one or more size-dependent layers with size-specific parameters are normalization layers.

Example 4 provides for the method of any of examples 1-3, wherein training the parameters of the computer model includes determining an ensemble segmentation prediction based on the plurality of size-specific segmentation prediction and training the parameters is based on reducing a training loss that includes a loss of the ensemble segmentation prediction.

Example 5 provides for the method of example 4, wherein training the parameters of the computer model includes training weights of the respective plurality of size-specific segmentation predictions for determining the ensemble segmentation prediction.

Example 6 provides for the method of any of examples 1-5, wherein training the parameters of the computer model includes a distillation loss of a sequence of teaching labels based on an order of the respective image resolutions of the plurality of size-specific segmentation predictions.

Example 7 provides for the method of example 6, wherein the distillation loss includes an ensemble segmentation prediction as a first teacher in the sequence of teaching labels.

Example 8 provides for the method of any of examples 1-7, wherein the size-specific segmentation predictions are resized to a maximum image resolution for comparison to the image label.

Example 9 provides for a system including a processor; and a non-transitory computer-readable storage medium containing computer program code for execution by the processor for: resizing a training image to a plurality of training images at different image resolutions; generating a plurality of size-specific segmentation outputs by applying each of the training images to a computer model to generate an associated size-specific segmentation prediction for each training image resolution, the computer model having a shared convolutional layer with the same parameters applied to each image resolution; and training parameters of the computer model, including parameters of the shared convolutional layer, based on a comparison of the plurality of size-specific segmentation predictions with a label of the training image.

Example 10 provides for the system of example 9, wherein the computer model includes one or more size-dependent layers with size-specific parameters.

Example 11 provides for the system of example 10, wherein the one or more size-dependent layers with size-specific parameters are normalization layers.

Example 12 provides for the system of any of examples 9-11, wherein training the parameters of the computer model includes determining an ensemble segmentation prediction based on the plurality of size-specific segmentation prediction and training the parameters is based on reducing a training loss that includes a loss of the ensemble segmentation prediction.

Example 13 provides for the system of example 12, wherein training the parameters of the computer model includes training weights of the respective plurality of size-specific segmentation predictions for determining the ensemble segmentation prediction.

Example 14 provides for the system of any of examples 9-13, wherein training the parameters of the computer model includes a distillation loss of a sequence of teaching labels based on an order of the respective image resolutions of the plurality of size-specific segmentation predictions.

Example 15 provides for the system of example 14, wherein the distillation loss includes an ensemble segmentation prediction as a first teacher in the sequence of teaching labels.

Example 16 provides for the system of any of examples 9-15, wherein the size-specific segmentation predictions are resized to a maximum image resolution for comparison to the image label.

Example 17 provides for a non-transitory computer-readable storage medium containing instructions executable by a processor for: resizing a training image to a plurality of training images at different image resolutions; generating a plurality of size-specific segmentation outputs by applying each of the training images to a computer model to generate an associated size-specific segmentation prediction for each training image resolution, the computer model having a shared convolutional layer with the same parameters applied to each image resolution; and training parameters of the computer model, including parameters of the shared convolutional layer, based on a comparison of the plurality of size-specific segmentation predictions with a label of the training image

Example 18 provides for the non-transitory computer-readable storage medium of example 17, wherein the computer model includes one or more size-dependent layers with size-specific parameters.

Example 19 provides for the non-transitory computer-readable storage medium of example 18, wherein the one or more size-dependent layers with size-specific parameters are normalization layers.

Example 20 provides for the non-transitory computer-readable storage medium of any of examples 17-19, wherein training the parameters of the computer model includes determining an ensemble segmentation prediction based on the plurality of size-specific segmentation prediction and training the parameters is based on reducing a training loss that includes a loss of the ensemble segmentation prediction.

Example 21 provides for the non-transitory computer-readable storage medium of example 20, wherein training the parameters of the computer model includes training weights of the respective plurality of size-specific segmentation predictions for determining the ensemble segmentation prediction.

Example 22 provides for the non-transitory computer-readable storage medium of any of examples 17-21, wherein training the parameters of the computer model includes a distillation loss of a sequence of teaching labels based on an order of the respective image resolutions of the plurality of size-specific segmentation predictions.

Example 23 provides for the non-transitory computer-readable storage medium of example 22, wherein the distillation loss includes an ensemble segmentation prediction as a first teacher in the sequence of teaching labels.

Example 24 provides for the non-transitory computer-readable storage medium of any of examples 17-23, wherein the size-specific segmentation predictions are resized to a maximum image resolution for comparison to the image label.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method comprising:
resizing a training image to a plurality of training images at different image resolutions;
generating a plurality of size-specific segmentation outputs by applying each of the training images to a computer model to generate an associated size-specific segmentation prediction for each training image resolution, the computer model having a shared convolutional layer with the same parameters applied to each image resolution; and
training parameters of the computer model, including parameters of the shared convolutional layer, based on a comparison of the plurality of size-specific segmentation predictions with a label of the training image.

2. The method of claim 1, wherein the computer model includes one or more size-dependent layers with size-specific parameters.

3. The method of claim 2, wherein the one or more size-dependent layers with size-specific parameters are normalization layers.

4. The method of claim 1, wherein training the parameters of the computer model includes determining an ensemble segmentation prediction based on the plurality of size-specific segmentation prediction and training the parameters is based on reducing a training loss that includes a loss of the ensemble segmentation prediction.

5. The method of claim 4, wherein training the parameters of the computer model includes training weights of the respective plurality of size-specific segmentation predictions for determining the ensemble segmentation prediction.

6. The method of claim 1, wherein training the parameters of the computer model includes a distillation loss of a sequence of teaching labels based on an order of the respective image resolutions of the plurality of size-specific segmentation predictions.

7. The method of claim 6, wherein the distillation loss includes an ensemble segmentation prediction as a first teacher in the sequence of teaching labels.

8. The method of claim 1, wherein the size-specific segmentation predictions are resized to a maximum image resolution for comparison to the image label.

9. A system comprising:
a processor; and
a non-transitory computer-readable storage medium containing computer program code for execution by the processor for:
resizing a training image to a plurality of training images at different image resolutions;
generating a plurality of size-specific segmentation outputs by applying each of the training images to a computer model to generate an associated size-specific segmentation prediction for each training image resolution, the computer model having a shared convolutional layer with the same parameters applied to each image resolution; and
training parameters of the computer model, including parameters of the shared convolutional layer, based on a comparison of the plurality of size-specific segmentation predictions with a label of the training image.

10. The system of claim 9, wherein the computer model includes one or more size-dependent layers with size-specific parameters.

11. The system of claim 10, wherein the one or more size-dependent layers with size-specific parameters are normalization layers.

12. The system of claim 9, wherein training the parameters of the computer model includes determining an ensemble segmentation prediction based on the plurality of size-specific segmentation prediction and training the parameters is based on reducing a training loss that includes a loss of the ensemble segmentation prediction.

13. The system of claim 12, wherein training the parameters of the computer model includes training weights of the respective plurality of size-specific segmentation predictions for determining the ensemble segmentation prediction.

14. The system of claim 9, wherein training the parameters of the computer model includes a distillation loss of a sequence of teaching labels based on an order of the respective image resolutions of the plurality of size-specific segmentation predictions.

15. The system of claim 14, wherein the distillation loss includes an ensemble segmentation prediction as a first teacher in the sequence of teaching labels.

16. The system of claim 9, wherein the size-specific segmentation predictions are resized to a maximum image resolution for comparison to the image label.

17. A non-transitory computer-readable storage medium containing instructions executable by a processor for:
resizing a training image to a plurality of training images at different image resolutions;
generating a plurality of size-specific segmentation outputs by applying each of the training images to a computer model to generate an associated size-specific segmentation prediction for each training image resolution, the computer model having a shared convolutional layer with the same parameters applied to each image resolution; and
training parameters of the computer model, including parameters of the shared convolutional layer, based on a comparison of the plurality of size-specific segmentation predictions with a label of the training image.

18. The non-transitory computer-readable medium of claim 17, wherein the computer model includes one or more size-dependent layers with size-specific parameters.

19. (canceled)

20. The non-transitory computer-readable medium of claim 17, wherein training the parameters of the computer model includes determining an ensemble segmentation prediction based on the plurality of size-specific segmentation prediction and training the parameters is based on reducing a training loss that includes a loss of the ensemble segmentation prediction.

21. (canceled)

22. The non-transitory computer-readable medium of claim 17, wherein training the parameters of the computer model includes a distillation loss of a sequence of teaching labels based on an order of the respective image resolutions of the plurality of size-specific segmentation predictions.

23. (canceled)

24. (canceled)
